(19) United States
(12) Patent Application Publication
(10) Pub. No.: US 2008/0197740 A1
(43) Pub. Date: Aug. 21, 2008

(54) Modular motor or alternator assembly

(76) Inventor: William L. Hughes, Rapid City, SD (US)

Correspondence Address: Gene R. Woodle, 3516 Woodle Drive, Rapid City, SD, 57702, US

(21) Appl. No.: 11/707,407

(22) Filed: Feb. 15, 2007

(51) Int. Cl. H02K 3/00; H02K 3/46

(52) U.S. Cl. 310/184; 310/270

(57) ABSTRACT

A modular motor or alternator assembly which comprises an alternator or a motor having a rotor with longitudinal lobes and no windings, commutators, slip rings, magnets, or laminations. A number of modules are provided including two end bell modules, a stator and field coil module, a field coil module, and a stator module. A plurality of stator and field coil modules, field coil modules, and stator modules may be combined with the two end bell modules and a rotor to create a wide variety of motors or alternators having using combinations of standard modules. For instance, motor of various horsepowers can be created using multiple standardized modules.

### BACKGROUND OF THE INVENTION

1. Field of the Invention

The present invention relates generally to electric motors and alternators and more specifically to a modular motor or alternator assembly which is modular such that modules may be combined to increase power without the need to change or increase the size of the module.

2. Background Information

All around the United States and throughout the world, millions of people use electric motors and alternators on a daily basis. Conventional motors and alternators have a variety of configurations, but ordinarily have a cylindrical case. A stator having the general shape of a hollow cylinder fits inside the case and generally consists of series of windings of conducting wire (most often copper) in which layers of windings are often separated by insulating laminations. It is well known in the art that the method of winding stators determines whether the resulting current is single phase, two phase, three phase, or some multiphase. Ordinarily a rotor revolves on bearings in the ends of the case. The end portions of the case are ordinarily known as the end bells. The rotor may have windings or some other method of creating a permanent magnet or an electromagnet to create a magnetic flux around the rotor. Rotors historically may also include such well known devices as brush, commutator, or slip ring components necessary to the operation of an alternator or motor.

Conventional motors are usually measured using a horsepower rating. That is, a ten horsepower motor generally produces twice as much power as a five horsepower motor. Traditionally, a ten horsepower motor is physically larger than a five horsepower motor in all dimensions. That is, the rotors, stators, case, end bells, etc. are larger for a ten horsepower motor than for a five horsepower motor. This entails making a large variety of different components to create motors of different horsepower.

For a variety of well established reasons, standard electric power operates at a frequency of 50 or 60 Hz. Because of their necessary configurations, the fastest conventional alternators can run for generating conventional electric power is t 3,600 rpm at 60 Hz and 3,000 rpm for 50 Hz. If a device such as a modem turbine which may easily operate a speeds of around 50,000 rpm's is used to power such alternators, the speed must be mechanically reduced to either 3,600 rpm or 3,000 rpm to function properly. Furthermore, the operating speed of the turbine must be rigidly controlled for proper operation.

Furthermore, the flux in a rotor and in a stator create what amounts to a mechanical resistance which must be overcome in a conventional electric motor at start up. It is well known that such a motor requires up to 6 times running current to overcome this initial resistance.

Of course, it should be understood that alternators and motors have almost identical characteristics and most of the above applies to alternators as well as to motors.

The modular motor or alternator assembly of the instant invention solves a number of problems common to conventional motors and alternators. The rotor of the instant invention is solid and does not include windings, brushes, commutators, slip rings, or embedded magnets. A high speed drive device such as a turbine may be used without the necessity of using mechanical speed reduction. There is no startup current spike. Further the instant invention provides wide ranging torque and speed characteristics not known in the prior art without the need for a mechanical transmission. The modular motor or alternator assembly of the instant invention also provides solutions to many of the problems relating to the manufacture of motors and alternators of different sizes by providing a modular stator and coil unit which can be used to make motors of different power by simply adding more stator and coil units. For example, five, identical, one horsepower stator and coil units could be used to create a five horsepower motor.

The ideal modular motor or alternator assembly should operate with a rotor having no windings, brushes, commutators, slip rings, or embedded magnets. The ideal modular motor or alternator assembly (in its alternator aspect) should provide for the use of a high speed power source such as a turbine without the need for mechanical speed reduction. The ideal modular motor or alternator assembly should eliminate the startup power spike found in conventional electric motors. The ideal modular motor or alternator assembly should also provide wide ranging torque and speed characteristics not known in the prior art without the need for a mechanical transmission. The ideal modular motor or alternator assembly should also be created in a modular unit which may be used in multiple units to easily create motors or alternators having different power using the same module. The ideal modular motor or alternator assembly should also be simple, reliable, inexpensive, and easy to install and use.

### SUMMARY OF THE INVENTION

The modular motor or alternator assembly of the instant invention may be operated as an alternator or as a motor. The physical configuration of the alternator and the motor is basically the same. A case is provided which has the general shape of a hollow cylinder and which has end bells with bearings at either end. The module case is made of a magnetic flux conducting material. A conventionally wound stator fits within the module case and is located at one end of the module case. The stator is wound for multiple phase operation. A field winding which is simply a coil of insulated copper wire in the preferred embodiment, is located at the other end of the module case. A solid steel rotor having a generally cylindrical shape rides on the bearings in the end bells. The rotor has a drive shaft which protrudes from one of the bearings in one of the end bells and a ride shaft which rides on the other bearing in the other end bell.

The rotor in the preferred embodiment has six lobes which run parallel to the longitudinal axis of the case, but more or fewer lobes could be used depending upon the desired configuration of the motor or alternator. These lobes are arrayed regularly around the circumference of the rotor. There is an air gap between the outer surface of the lobes of the rotor and the inner surface of the stator as well as between the outer surface of the lobes and the field winding. In the preferred embodiment of the instant invention, the air gap between the lobes and the field winding is greater than the air gap between the lobes and the stator.

A relatively small direct current is passed through the field winding. This has the effect of creating a north pole at one end and a south pole at the other end of the lobes of the rotor. By any of a number of conventional means, the current directed through the field coil may easily be controlled and, thus, the strength of the magnetic field induced in the lobes of the rotor may easily be controlled.

Several modules are created. There is a module for each of the end bells, a module which consists of a case portion having a stator and a field winding, and a module which consists of a case portion and a stator. The modules are manufactured such that the various modules may be fastened together securely with any number of modules hooked together. In the simplest form, the two end bell modules may be hooked together with a stator and field winding module, and a stator module to create a motor or alternator. Additional stator and field winding modules may be added, as desired, to, for instance, create a motor having greater power than a motor having a single stator and field winding module. In this manner various motors and alternators may be created using only single sized standardized parts or modules.

When the instant invention is being operated as an alternator, the drive shaft of the rotor may be connected to a prime mover such as a high speed turbine. The turbine turns the rotor at any efficient speed, such as 50,000 rpm. That is, the flux of the rotor may be reduced to nearly zero by having very little current in the field winding at startup. As with a conventional alternator, the rotation of the polarized lobes of the rotor induces an electric current in the windings of the two stators. The frequency of this current would be many times higher than the conventionally usable 60 Hz or 50 Hz.

In its motor configuration, the instant invention is the same as in the alternator description above except that the drive shaft powers any operating unit such as a wheel, gear or any other device which might be driven by an electric motor.

The above describes the basic operating principal of the modular motor or alternator assembly of the instant invention in one embodiment. There are a number of other embodiments and elements which are described in detail below.

One of the major objects of the present invention is to provide either an alternator or a motor which operates with a rotor having no windings, brushes, commutators, slip rings, or embedded magnets.

Another objective of the present invention to provide for the use of a high speed power source such as a turbine without the need for mechanical speed reduction.

Another objective of the present invention is to eliminate the startup power spike found in conventional electric motors.

Another objective of the present invention is to provide wide ranging torque and speed characteristics without the need for a mechanical transmission.

Another objective of the present invention is to provide a modular unit which may be used in multiple units to easily create motors or alternators having different power using the same module.

Another objective of the present invention is to provide a modular motor or alternator assembly which is simple, reliable, inexpensive, and easy to install and use.

These and other features of the invention will become apparent when taken in consideration with the following detailed description and the drawings.

### BRIEF DESCRIPTION OF THE DRAWINGS

FIG. 1 is a side view of the modular motor or alternator assembly of the instant invention;

FIG. 2 is a sectional view the alternator aspect of the instant invention taken along line 2-2 of FIG. 1;

FIG. 3 is sectional view of the alternator aspect of the instant invention taken along line 3-3 of FIG. 1;

FIG. 4 is a sectional view of the alternator aspect of the instant invention showing several rotor and field winding modules used together;

FIG. 5 is a side view of the rotor of the instant invention;

FIG. 6 is sectional view of rotor of the instant invention taken along line 6-6 of FIG. 5;

FIG. 7 is a side view of a second rotor embodiment of the instant invention; and

FIG. 8 is sectional view of the second rotor embodiment taken along line 8-8 of FIG. 7.

### DESCRIPTION OF A PREFERRED EMBODIMENT

Referring to the drawings, FIGS. 1 through 8, there is shown a preferred embodiment of the modular motor or alternator assembly of the instant invention. The instant invention is shown and described below as an alternator, but could be used just as well as a motor.

Now referring to FIG. 1, side view of the alternator aspect of the modular motor or alternator assembly of the instant invention is shown. An alternator 2 includes a case 4 and two end bells 6. A rotor 8 fits within the case 4 and protrudes from said case 4 sufficiently to provide an alternator shaft 10. A plurality of bolts 12 removably affixed the end bells 6 to said case 4.

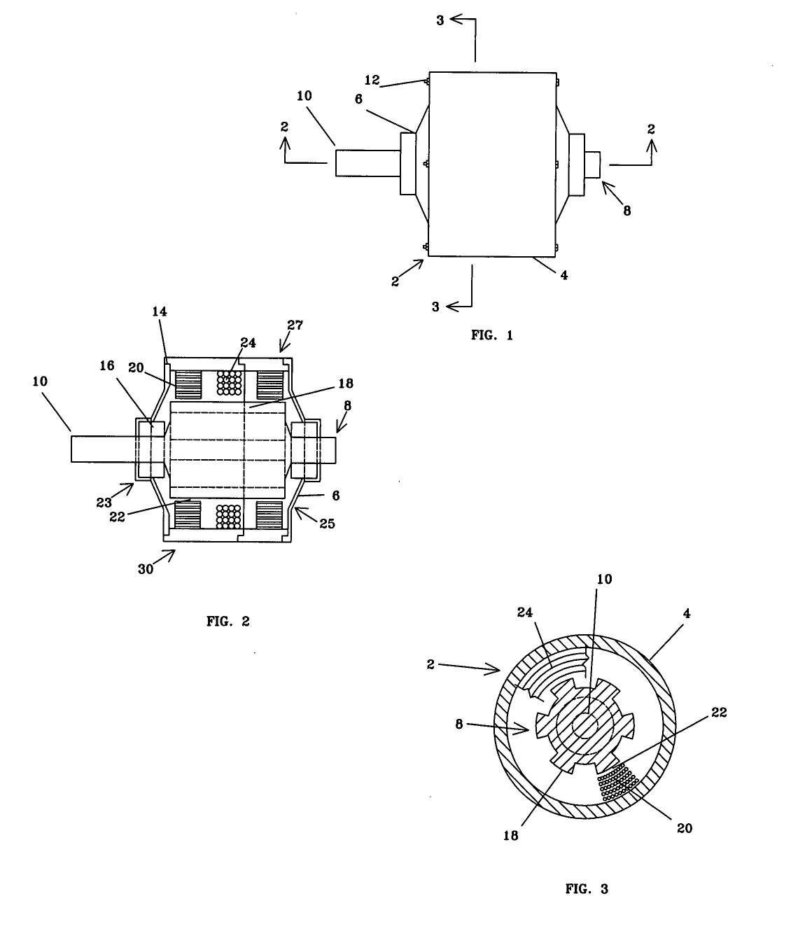

Referring now to FIG. 2, a sectional view of said alternator 2 of the instant invention taken along line 2-2 of FIG. 1 is shown. (This sectional view also shows a sectional view of the motor aspect of the instant invention with very few differences as described in detail below.) Said case 4 has the general shape of a hollow cylinder and includes key ways 14 around its circumference which tend to hold said end bells 6 in position against said case 4. Said end bells 6 include a pair of bearings 16 which hold said rotor 8 in place and reduce friction on said rotor 8. The outer surface of said case 4 provides a means for conducting the magnetic flux longitudinally. Said rotor 8 has the general shape of a solid cylinder, however, six equally spaced lobes 18 protrude outward from said rotor 8 and run the length of said rotor 8 along the longitudinal axis of said case 4. In other embodiments, said rotor 8 may have more than or less than six of the lobes 18. A stator 20 having the general shape of a hollow cylinder is affixed to the inner surface of said case 4 such that there is an air gap 22 between the inner surface of the stator 20 and the outer surface of said lobes 18 on said rotor 8. Said stator 20 is located one end of said case 4. Except for their position and configuration, said stator 20 is conventionally wound for multiple phase output and laminated with insulating layers between the windings. Production of similar stators is well known in the art. A field winding 24, having the general shape of a hollow cylinder, is affixed to the inner surface of said case 4 at the end of said case 4 opposite said stator 20. In the preferred embodiment, the field winding 24 is 200 turns of #16 enameled copper wire roughly square in cross section. Of course, different wire used in a different number of turns would also work.

Still referring to FIG. 2, a relatively small direct current is passed through said field winding 24 by any of a number of conventional DC sources. This DC source could be a conventional 12 volt car battery. According to well known principles, the direct current in said field winding 24 polarizes said lobes 18 in said rotor 8 creating a north pole at one end of said lobes 18 and a south pole at the other end. A conventional prime mover (which could, for instance, be a gas turbine) turns said alternator shaft 10 at, for example, 50,000 rpm which, of course, turns said rotor 8 at the same speed. Again, according to principles well known in the art, the spinning of said rotor 8 with its polarized lobes 18 within said stator 20 generates a multiple phase current within said stator 20 at a frequency proportional to the speed of the prime mover. The strength of this generated current within said stators 20 depends upon the strength of the magnetization within said lobes 18. The strength of this magnetization is easily controlled by the direct current within said field winding 24.

Still referring to FIG. 2, this shows the simplest configuration of the motor or alternator of the instant invention and includes four modules: a first bell end module 23, a second bell end module 25, a stator and field winding module 30, and a stator module 27. The first bell end module 23 includes one of said bearings 16 and fits into one of said keyway 14 on one end of the stator and field winding module 30. The stator module 27 fits into the other of said keyways 14 on the other end of said stator and field winding module 30. The second bell end module 25 fits into the other of said keyways 14 on said stator module 27. Said rotor 8 rests upon said bearings 16 in said first bell end module 23 and said second bell end module 25. The various modules are removably fastened together using said bolts 12 (not shown in this figure), but other methods of fastening could be used. The various elements are wired in a conventional manner.

Referring now to FIG. 3, sectional view of the instant invention taken along line 3-3 of FIG. 1 is shown. This view better shows the configuration and relationship of some of the elements previously described. Said case 4 carries some magnetic field complementary to the polarizing direct current induced in said lobes 18 of said rotor 8. As may be clearly seen in this Figure, said field winding 24 encircles, but does not touch said rotor 8. This Figure, perhaps, also gives a better sense of the alignment and position of the windings in said stator 20. Note said air gap 22 between said stator 20 and the outermost surface of said lobes 18.

Referring again to FIG. 1, in the motor embodiment of the instant invention, the motor aspect is nearly the same as said alternator 2. Physically, the only differences between the motor aspect and said alternator 2 are that what is shown in this Figure as said alternator shaft 10 becomes a motor drive shaft.

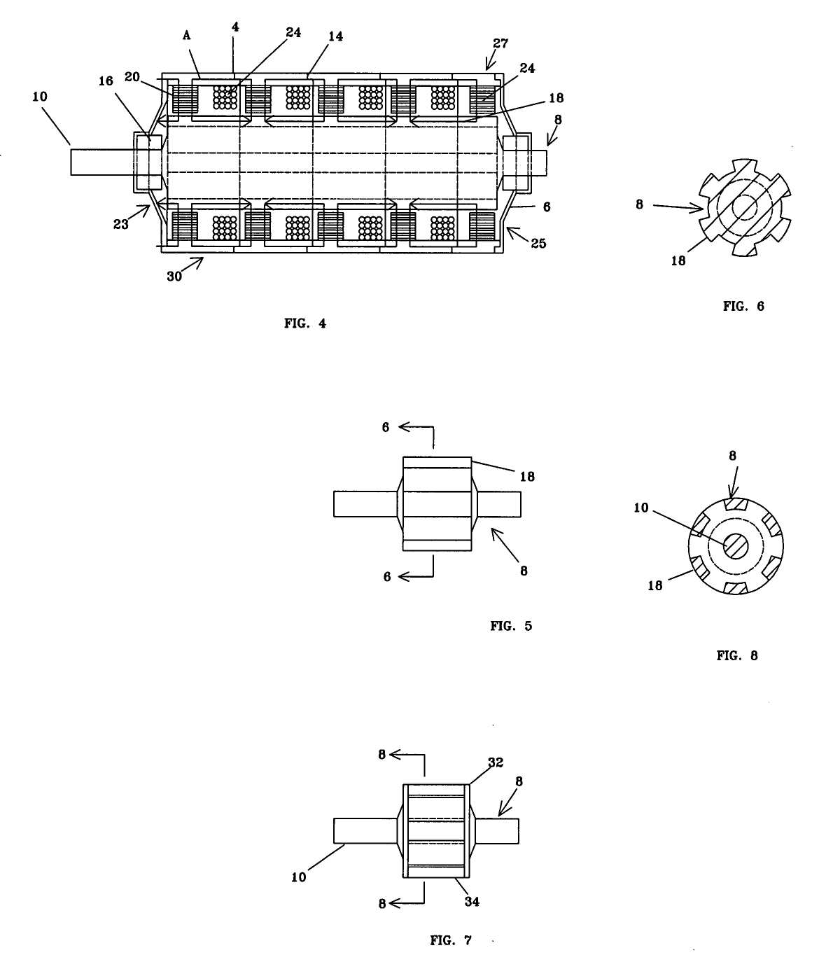

Referring now to FIG. 4, a sectional view of the alternator aspect of the instant invention showing several stator and field winding modules 30 used together with said first bell end module 23, said stator module 27, and said second bell end module 25. As can be seen, said key ways 14 in said stator and field winding modules 30, said first bell end module 23, said second bell end module 25, and said stator module 27 act to keep said rotor 8 and the various modules secure and properly positioned. This figure shows four of said stator and field winding modules 30 being used, but any number of them could be used to produce the desired result. The bolts 12 (not shown in this Figure) pass through the various modules and hold them all securely together. Said rotor 8 is lengthened such that it fits within the modules and functions in the same manner as described above. Although, in the preferred embodiment, said rotor 8 is lengthened, it should be apparent that said rotor 8 could also be modular with two end pieces and a center piece which could be held together with bolts in the same manner as said stator and field winding modules 30. Said rotor 8 could be lengthened by using as many center pieces as necessary. Again, the motor aspect of the instant invention is the same as the above described alternator aspect except that said alternator shaft 10 becomes a motor drive shaft. As is well known in the field, with an alternator a prime mover would be used to turn said alternator shaft 10 to produce an electric current which would be drawn from said stators 20. In the motor aspect of the instant invention an electric current would be introduced to said stators 20 which would cause said rotor 8 and the motor drive shaft to turn.

Still referring to FIG. 4, the magnetic flux lines A in the instant invention are shown. Because the magnetic field changes direction in every one of said stator and field winding modules 30 and said stator module 27, the thickness of the outer walls of said case 4 needs to be only half as thick as that of a conventional motor or alternator. This provides for a much lighter motor or alternator with the modular motor or alternator assembly of the instant invention. As is well known in the field of alternators and motors, both stator windings and field windings may be connected in series, in parallel, or in some combination of the two to allow for different desired voltages and currents.

Referring now to FIG. 5, a side view of said rotor 8 of the instant invention is shown. Said rotor 8 is of conventional shape, but is made from solid steel and has no windings, brushes, etc. Said rotor 8 has six equally spaced lobes 18 along the longitudinal axis of said rotor 8 which protrude outward from the center of said rotor 8, but other numbers of lobes could be used as required.

Referring now to FIG. 6, a sectional view of said rotor 8 taken along line 6-6 of FIG. 5 is shown. This view better shows the position and relationship of said lobes 18 on said rotor 8.

Referring now to FIG. 7, a side view of a second embodiment of said rotor 8 of the instant invention is shown. In this embodiment, rather than being solid, said lobes 18 are steel bars 34 which are affixed (by welding in this embodiment) to a pair of end plates 32. One of the end plates 32 includes said alternator shaft 10. The steel bars 34 need be only half as thick as they would have to be with a conventional motor or alternator.

Referring now to FIG. 8, a sectional view of the second embodiment of said rotor 8 taken along line 8-8 of FIG. 7. This view better shows the position and relationship of the bars 34 and said end plates 32.

It should be understood that the embodiments of said rotor 8 shown in FIGS. 7 and 8 work in exactly the same manner as described above for the first embodiment of said rotor 8 and may be used in either the alternator aspect or the motor aspect of the instant invention. This embodiment is lighter but not as strong as the first embodiment of said rotor 8 and could be used in situations where strength is less important than light weight.

In operation, the alternator aspect and the motor aspect of the instant invention function is the same manner as conventional alternators and motors with the exception of said rotor 8 and said field winding 24. Rather than having permanent magnets or coils to create electromagnets, said lobes 18 of said rotor 8 are magnetized by passing a DC current through said field winding 24. The strength of the polarity of said lobes 18 is controlled by the amount of current passed through said field winding 24.

All elements of the modular motor or alternator assembly are made of steel, but other materials having similar strength, and magnetic properties could be used. Said field winding 24 is made with copper wire, but other conducting material could be used. While preferred embodiments of this invention have been shown and described above, it will be apparent to those skilled in the art that various modifications may be made in these embodiments without departing from the spirit of the present invention. That is, the device could be used for a wide variety of purposes either in combination or separately.

I claim:

1. An electric motor having a number of modules comprising:
(1) a first end bell module having a circular shape and including a round bearing at its center;
(2) a stator and field coil module in which a conventionally wound stator having the shape of a hollow cylinder and a field coil made up of a wound coil of electricity conducting wire and having the shape of a hollow cylinder are affixed to the inside of a case made of magnetic flux conducting material and having the shape of a hollow cylinder;
(3) means for passing a DC current through said field coil;
(4) a stator module in which a conventionally wound stator having the shape of a hollow cylinder is affixed to the inside of a second case made of magnetic flux conducting material having the shape of a hollow cylinder;
(5) a second end bell module having a circular shape and including a round bearing at its center;
(6) a rotor having a plurality of lobes made of magnetic material and protruding outward from the rotor which is capable of rotating relative to the stators and there being an air gap between the lobes and said stators and said field coil and said rotor rides within the round bearings in the first end bell module and the second end bell module and in which said lobes are capable of being polarized by passing the DC current through said field coil; and
(7) means for securing said first end bell module, said stator and field coil module, said stator module, and said second end bell module to each other with said rotor inside;
whereby electric current is passed through said stators and said lobes on said rotor are polarized to create a motor.

2. The electric motor of claim 1 in which an additional module is added which is a field coil module including a case made of magnetic flux conducting material and having the shape of a hollow cylinder and a field coil made up of a wound coil of electricity conducting wire and having the shape of a hollow cylinder affixed to the inside of the case.

3. An electric alternator having a number of modules comprising:
(1) a first end bell module having a circular shape and including a round bearing at its center;
(2) a stator and field coil module in which a conventionally wound stator having the shape of a hollow cylinder and a field coil made up of a wound coil of electricity conducting wire and having the shape of a hollow cylinder are affixed to the inside of a case made of magnetic flux conducting material and having the shape of a hollow cylinder;
(3) means for passing a DC current through said field coil;
(4) a stator module in which a conventionally wound stator having the shape of a hollow cylinder is affixed to the inside of a second case made of magnetic flux conducting material having the shape of a hollow cylinder;
(5) a second end bell module having a circular shape and including a round bearing at its center;
(6) a rotor having a plurality of lobes made of magnetic material and protruding outward from the rotor which is capable of rotating relative to the stators and there being an air gap between the lobes and said stators and said field coil and said rotor rides within the round bearings in the first end bell module and the second end bell module and in which said lobes are capable of being polarized by passing the DC current through said field coil; and
(7) means for securing said first end bell module, said stator and field coil module, said stator module, and said second end bell module to each other with said rotor inside;
whereby said lobes on said rotor are polarized and said rotor is turned by some prime mover to create an alternator.

4. The electric alternator of claim 3 in which an additional module is added which is a field coil module including a case made of magnetic flux conducting material and having the shape of a hollow cylinder and a field coil made up of a wound coil of electricity conducting wire and having the shape of a hollow cylinder affixed to the inside of the case.

5. The electric motor of claim 1 in which a plurality of additional stator and field winding modules are added to create different sized motors.

6. The electric motor of claim 2 in which a plurality of additional stator and field winding modules and field coil modules are added to create different sized motors.

7. The electric alternator of claim 3 in which a plurality of additional stator and field winding modules are added to create different sized alternators.

8. The electric alternator of claim 4 in which a plurality of additional stator and field winding modules and field coil modules are added to create different sized alternators.
